(19) United States
(12) Patent Application Publication
(10) Pub. No.: US 2009/0316178 A1
(43) Pub. Date: Dec. 24, 2009

(54) IMAGE FORMING APPARATUS AND METHOD FOR CONTROLLING IMAGE FORMING APPARATUS

(75) Inventor: Tomoji TANAKA, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/399,303

(22) Filed: Mar. 6, 2009

(30) Foreign Application Priority Data
Jun. 18, 2008 (JP) 2008-159502

(51) Int. Cl. G06K 15/00

(52) U.S. Cl. 358/1.14; 358/1.15

(57) ABSTRACT

An image forming apparatus is provided with a receiving portion receiving an authenticated print job, a storage portion storing image data of the authenticated print job thus received, an authentication information determination portion performing authentication based on an operation performed by the user, and a printer printing an image based on the image data stored in the storage portion when the user has been authenticated. When the operation mode is set to the power-saving mode, the power controller changes the operation mode from the power-saving mode to the power-saving print mode without changing the operation mode from the power-saving mode to the normal standby mode after the user has been authenticated and before the printer performs printing, and the power controller returns the operation mode from the power-saving print mode to the power-saving mode after the printer has performed the printing.

This application is based on Japanese patent application No. 2008-159502 filed on Jun. 18, 2008, the contents of which are hereby incorporated by reference.

### BACKGROUND OF THE INVENTION

1. Field of the Invention

The present invention relates to an image forming apparatus such as an MFP, and a method for controlling an image forming apparatus.

2. Description of the Related Art

Conventionally, image forming apparatuses are used in an office of a company or the like. Such image forming apparatuses include copy machines, printers, and facsimile machines, as well as multifunction machines, which may be referred to as compound machines or MFPs (Multi Function Peripherals).

An image forming apparatus is provided with several power-saving modes for suppressing unnecessary standby power of devices. Known power-saving modes include a normal standby mode, a low power mode in which the temperature of a fixing unit is controlled to a lower temperature than in the normal standby mode, and a sleep mode in which supply of power to a drive system that includes the fixing unit is cut off.

Recent image forming apparatuses are configured so that it is possible to individually control the supply of power to each constituent portion, and in many cases, power consumption is suppressed as much as possible in the sleep mode. When a job has occurred such as network printing in which print output is instructed from a terminal apparatus, or facsimile receiving, only the minimum amount of power with which it is possible to shift to the normal standby mode is supplied.

Also, in the sleep mode, when performing network printing, print output is performed by supplying power only to the devices necessary for performing a print output operation, and power is not supplied to a scanner or the like that is not necessary for the print output operation. After print output, by immediately shifting to the sleep mode being used prior to the print output, an improvement in power-saving performance is realized.

Incidentally, recently, in image forming apparatuses, an authenticated print job is possible that allows print output only when an authentication was successful. IC card authentication apparatuses, and biometric authentication apparatuses such as finger vein authentication apparatuses, have been introduced as authentication apparatuses (see JP H11-249848A).

In an image forming apparatus provided with this sort of authentication apparatus, in the normal standby mode or in various power-saving modes, by performing an authentication login operation to the image forming apparatus, a user can perform various operations, such as faxing, scanning, copying, or print output. Accordingly, an image forming apparatus provided with an authentication apparatus is effectively utilized to manage jobs of individuals and departments within a company.

In the above conventional image forming apparatus, when an authenticated print job has been instructed from a terminal apparatus in a power-saving mode such as the sleep mode, that authenticated print job is temporarily stored in a box of a hard disk of the image forming apparatus. The user that instructed the authenticated print job goes to the location of the image forming apparatus and performs an authentication operation, and when the authentication was successful, print output is possible.

However, in a conventional image forming apparatus, in a state in which a power-saving mode such as the sleep mode is operating, the authentication operation by the user is judged to be an instruction to shift to the normal standby mode. That is, the authentication operation by the user triggers a shift from the sleep mode to the normal standby mode. In other words, the authentication operation by the user is judged to be a login operation for performing faxing, scanning, copying, printing, or the like, so a standby state is established. As a result of shifting to the normal standby mode in this way, in the image forming apparatus, a warm-up operation of a fixing unit, and initialization operations of an image creation process system and a reading system, are started. Therefore, unnecessary power consumption occurs.

Also, after print output ends, the normal standby mode is maintained until passage of a predetermined time for shifting to the sleep mode, so unnecessary power consumption occurs.

### SUMMARY

The present invention was made in view of such problems, and it is an object thereof to enable a reduction in unnecessary power consumption relative to the conventional technology.

An image forming apparatus according to one aspect of the present invention is an image forming apparatus configured to perform printing based on image data of a print job inputted from an external device. The image forming apparatus includes a power controller setting an operation mode of the image forming apparatus to any one of a normal standby mode, a power-saving mode and a power-saving print mode by changing a power supply destination in the image forming apparatus, the power-saving print mode being a mode for supplying power to the power supply destination necessary for executing the print job, a receiving portion receiving an authenticated print job that is a print job executed when authentication of a user who has inputted the print job through the external device is successful, a storage portion storing image data of the authenticated print job received by the receiving portion, an authentication information determination portion performing authentication based on a predetermined operation performed by the user, and a printer printing an image based on the image data stored in the storage portion when the authentication information determination portion determines that the authentication of the user is successful, when the operation mode is set to the power-saving mode, the power controller changing the operation mode from the power-saving mode to the power-saving print mode without changing the operation mode from the power-saving mode to the normal standby mode after the authentication information determination portion has determined that the authentication of the user is successful and before the printer performs printing, and the power controller returning the operation mode from the power-saving print mode to the power-saving mode after the printer has performed the printing.

### BRIEF DESCRIPTION OF THE DRAWINGS

FIG. 1 shows the general internal configuration of an image forming apparatus according to one embodiment of the present invention.

FIG. 2 is a block diagram that mainly shows the configuration of a control circuit of the image forming apparatus.

FIG. 3 is a block diagram that shows the configuration of a power controller.

FIG. 4 shows a plurality of operation modes of the image forming apparatus.

FIG. 5 is a flowchart that illustrates an example of the flow of an execution process of a normal print job.

FIG. 6 is a flowchart that illustrates an example of the flow of an execution process of an authenticated print job.

FIG. 7 is a flowchart that illustrates an example of the flow of a process for reducing power consumption.

### DESCRIPTION OF THE PREFERRED EMBODIMENTS

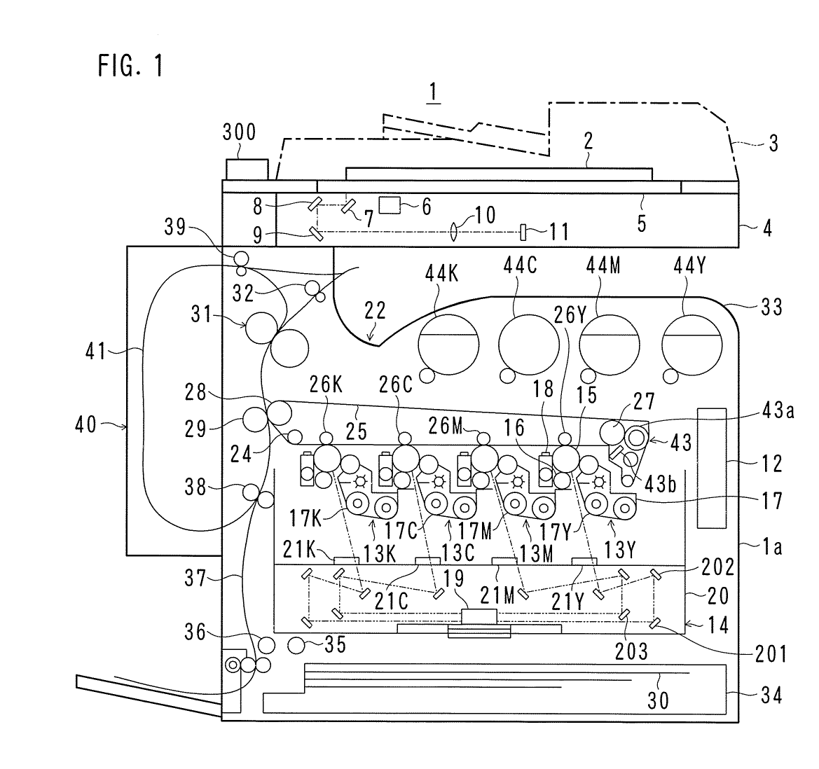

FIG. 1 shows the general internal configuration of an image forming apparatus 1 according to one embodiment of the present invention.

The image forming apparatus 1 is a processing apparatus in which various functions are gathered, such as copying, scanning, faxing, network printing, and document server functions. The image forming apparatus 1 may also be referred to as a compound machine, an MFP (Multi Function Peripheral), or the like.

A [document server] is a function of providing and managing storage areas that correspond to folders, directories, or the like in a personal computer for each user, which are referred to as ‘personal boxes’ or ‘boxes’. This may also be referred to as a ‘box function’. A user can store image data or the like in the user's personal box in file units.

The image forming apparatus 1 is installed in the offices of a public institution (government, local self-governing body), a company, or the like, public facilities such as schools or libraries, or various other locations, and can be used by a plurality of users.

The image forming apparatus 1 shown in FIG. 1 is a tandem-type digital color compound machine. The image forming apparatus 1 has a function of executing various jobs, such as a scan job of reading an image of a document that has been placed on an original table, and storing the read image on a hard disk apparatus or the like, a copy job of further printing the read image on paper or the like, a print job (network print job) of, when a print instruction has been received from an external terminal apparatus such as a personal computer, performing printing on paper based on that instruction, a facsimile job of receiving facsimile data from a facsimile apparatus or the like and storing the received facsimile data on a hard disk apparatus or the like, and a job of printing various data or images that have been stored on a hard disk apparatus or the like on paper.

As shown in FIG. 1, an automatic document transport apparatus (ADF) 3 and an image reading apparatus 4 are disposed in the upper portion of a main body la of the image forming apparatus 1. The automatic document transport apparatus 3 automatically transports a document 2 page by page in a separated state.

The image reading apparatus (scanner) 4 generates image data by optically reading an image (an image of the content of text, formulas, symbols, photographs, charts, illustrations, or the like) of the document 2 that has been transported by the automatic document transport apparatus 3.

That is, the image reading apparatus 4 irradiates a document 2 that has been transported and positioned onto a platen glass 5 with a light source 6, and via a reductive optical system constituted from a full-rate mirror 7, half-rate mirrors 8 and 9, and an imaging lens 10, scans and exposes a reflected light image from the document 2 on an image reading element 11 constituted from a CCD or the like. A color material reflected light image of the document 2 with a predetermined dot density, for example 16 dots/mm, is read by the image reading element 11.

The image reading apparatus 4 is provided with a document reading function as a compound machine that performs reading of document transmitted as a facsimile, and scan to e-mail/box storage. The color reflected light image of the document 2 that has been read by the image forming apparatus 4 is sent to an image processing portion 12 as, for example, document reflectance data in three colors, with 8 bits for each of red (R), green (G) and blue (B).

With the image processing portion 12, predetermined image processing is performed on the reflectance data of the document 2, such as shading correction, position offset correction, brightness/color space conversion, gamma correction, frame removal, and color/movement editing. The image processing portion 12 also performs predetermined image processing on image data that is sent from a personal computer or the like.

Image data on which predetermined image processing has been performed by the image processing portion 12 in this manner is, likewise by the image processing portion 12, converted to document reproduction color tone data in four colors, with 8 bits for each of yellow (Y), magenta (M), cyan (C), and black (K). The image data of each color Y, M, C, K is sent to a print head portion 14 of image forming units 13Y, 13M, 13C, and 13K. With the print head portion 14, which is an image exposure apparatus, image exposure is performed by a laser beam according to the document reproduction color tone data of a predetermined color.

Incidentally, because the image forming apparatus 1 is a tandem-type image forming apparatus, the four image forming units 13Y, 13M, 13C, and 13K are disposed in parallel at a fixed interval in the horizontal direction. These four image forming units 13Y, 13M, 13C, and 13K are configured to have the same specifications as each other. That is, each of these image forming units is configured with, for example, a photosensitive drum 15 as an image carrier that is rotationally driven at a predetermined speed, a charging roller 16 for primary charging that uniformly charges the surface of the photosensitive drum 15, the print head portion 14 as an image exposure apparatus that exposes an image corresponding to a predetermined color on the surface of the photosensitive drum 15 to form an electrostatic latent image, development units 17Y, 17M, 17C, and 17K that develop the electrostatic latent image that has been formed on the photosensitive drum 15 with toner of a predetermined color, and cleaning apparatuses 18Y, 18M, 18C, and 18K that clean the surface of the photosensitive drum 15.

The print head portion 14 is provided common to the four image forming units 13Y, 13M, 13C, and 13K. In the print head portion 14, four unshown semiconductor lasers are modulated according to the original reproduction color tone data of each color, and four laser beams are emitted according to the tone data. However, print head portions 14 may also be provided individually for each image forming unit. Each of the laser beams emitted from the four semiconductor lasers is irradiated onto one rotating polygon mirror 19, and thus deflected and scanned by the rotating polygon mirror 19. At that time, of the four laser beams that have been emitted from the four semiconductor lasers, the yellow and magenta laser beams are irradiated onto one side face of the rotating polygon mirror 19, the cyan and black laser beams are irradiated onto the side face of the opposite side of the rotating polygon mirror 19, and both are deflected and scanned by the rotating polygon mirror 19. As a result, the yellow and magenta laser beams and the cyan and black laser beams are deflected and scanned in opposite directions from each other by the rotating polygon mirror 19.

The laser beams that have been deflected and scanned by the rotating polygon mirror 19 are, via an unshown f-θ lens, reflected by a plurality of reflecting mirrors 201, 202, and 203, and after passing through windows 21Y, 21M, 21C, and 21K, scan and expose the surface of the photosensitive drum 15 of each image forming unit from diagonally below.

The electrostatic latent images that has been formed on the photosensitive drums 15 are developed by the development units 17Y, 17M, 17C, and 17K, and thus become toner images. The toner images of each color are transferred, superimposed on each other, by primary transfer rollers 26Y, 26M, 26C, and 26K, onto an intermediate transfer belt 25 of an intermediate transfer belt unit 22 that has been disposed throughout the area above each image forming unit 13Y, 13M, 13C, and 13K.

The intermediate transfer belt 25 is placed across a drive roller 27, a backup roller 28, and a tension roller 24 with a fixed tension, and is circularly driven at a predetermined speed by the drive roller 27, which is rotationally driven by an unshown dedicated drive motor whose speed is very constant. For example, an endless belt obtained by forming a synthetic resin film of polyimide or the like that has flexibility in a strip-like shape, and joining both ends of the synthetic resin film that has been formed in a strip-like shape by welding or the like, is used as the intermediate transfer belt 25.

The toner images of each color that have been transferred, superimposed on each other, onto the intermediate transfer belt 25 are secondarily transferred onto a transfer paper 30, used as a transfer material, by pressure and electrostatic force by a secondary transfer roller 29 that presses against the backup roller 28. The transfer paper 30 on which the toner images of each color have been transferred is transported to a fixing unit 31 positioned above.

The secondary transfer roller 29 is positioned to the side of the backup roller 28, and collectively performs secondary transfer of the toner images of each color onto the transfer paper 30 that is transported in the upward direction from below. The transfer paper 30 on which the toner images of each color have been transferred undergoes a heat and pressure fixing treatment by the fixing unit 31, and then is discharged onto a discharge tray 33 provided in the upper portion of the main body 1 by discharge rollers 32.

The transfer paper 30 is of a predetermined size and is transported from a paper cassette 34 to registration rollers 38 by a paper roller 35 and a pair of paper separation/transport rollers 36 via a paper transport path 37, and temporarily stops there. The transfer paper 30 is fed to the secondary transfer position of the intermediate transfer belt 25 by the registration rollers 38, which rotate at a predetermined timing.

Note that in the image forming apparatus 1, when performing duplex copying such as full-color copying, transfer paper 30 with an image formed on one face is not discharged in that state onto the discharge tray 33 by the discharge rollers 32, rather, the transport direction is switched by an unshown switching gate, and that paper is transported to a duplex transport unit 40 via a paper transport roller pair 39. Then, in a state in which the front and back of the transfer paper 30 have been reversed in the duplex transport unit 40 by an unshown transport roller pair provided along a transport path 41, the transfer paper 30 is transported again to the registration rollers 38. As a result, an image is transferred and fixed onto the back face of that same transfer paper 30, and then the transfer paper 30 is discharged onto the discharge tray 33. Note that toner of colors corresponding to toner cartridges 44Y, 44M, 44C, and 44K of each color is supplied from those toner cartridges to the respective development units 17 of each color.

Here, in this embodiment, an authentication apparatus 300 configured with a contact-type or non-contact-type IC card authentication apparatus or a finger vein authentication apparatus, for example, is connected to the image forming apparatus 1. The authentication apparatus 300 is an external apparatus for authenticating a user that has sent a print job from a terminal apparatus. This authentication apparatus may also be provided in the image forming apparatus 1 itself.

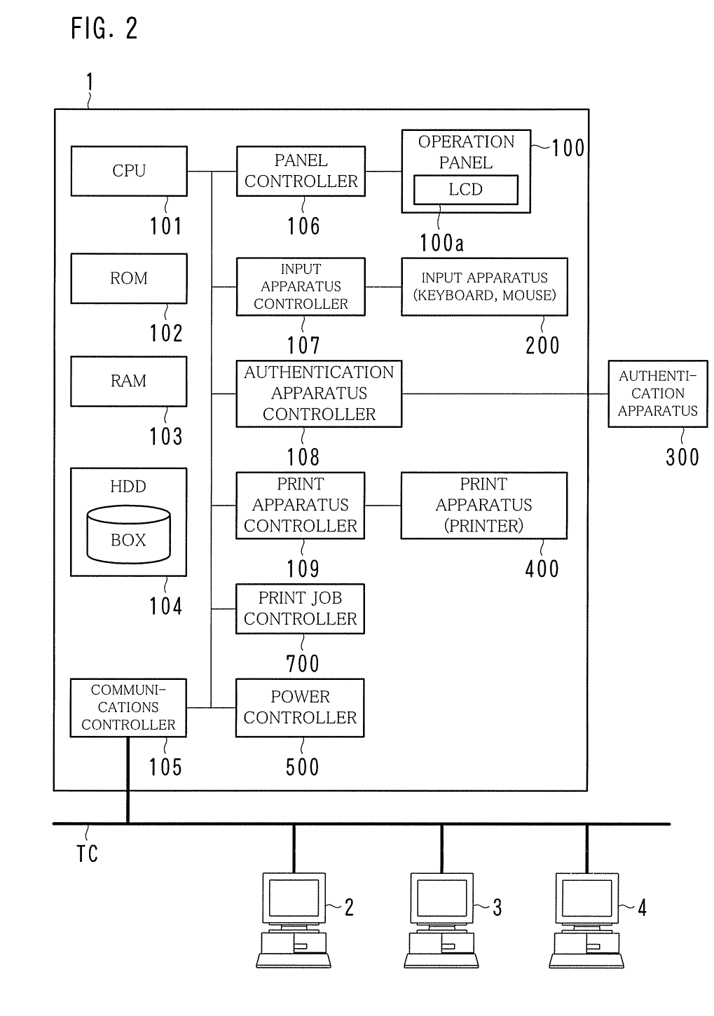

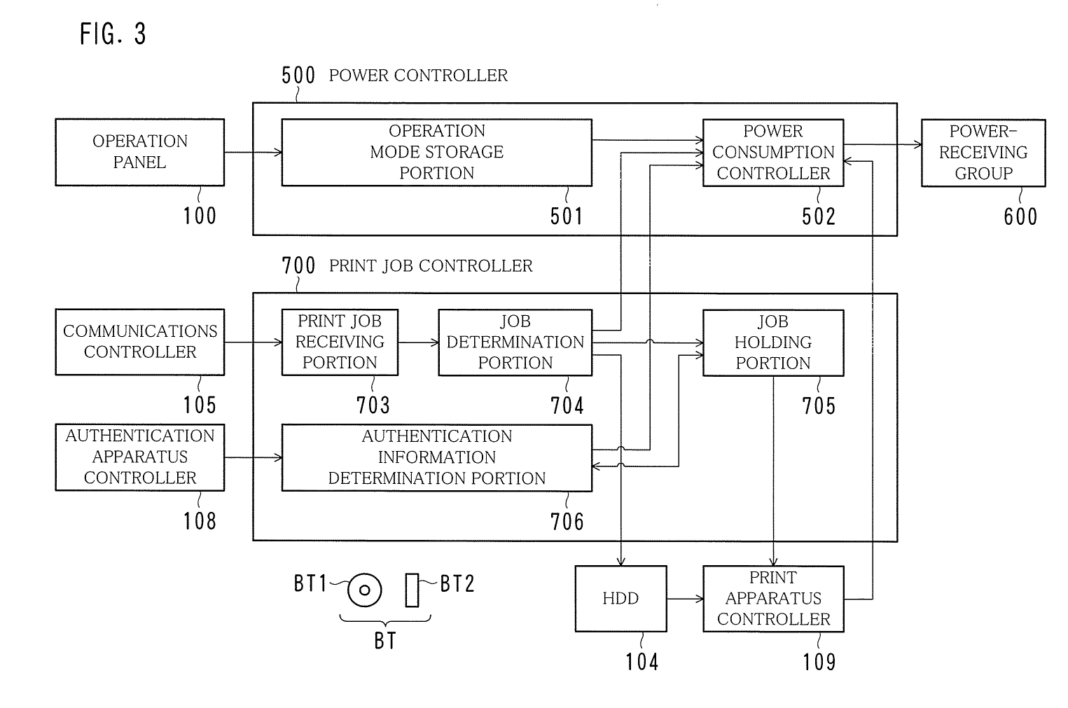

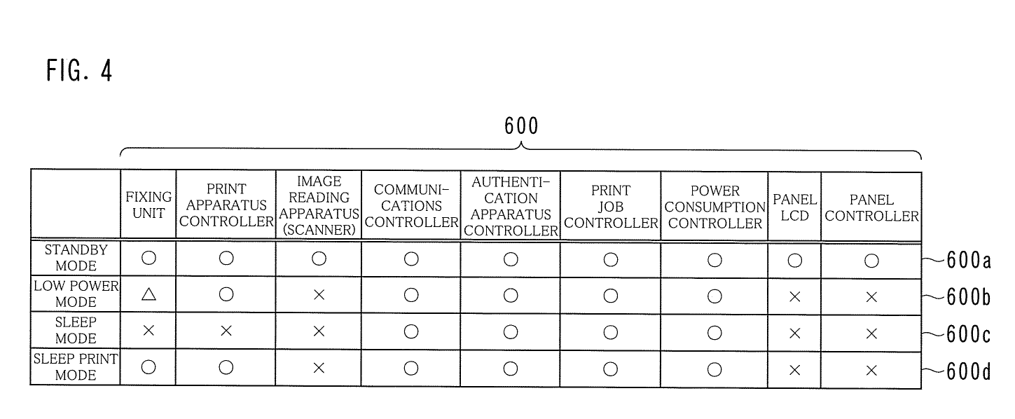

FIG. 2 is a block diagram that mainly shows the configuration of a control circuit of the image forming apparatus 1, FIG. 3 is a block diagram that shows the configuration of a power controller 500, and FIG. 4 shows a plurality of operation modes of the image forming apparatus 1.

As shown in FIG. 2, the image forming apparatus 1 is provided with, for example, a CPU 101, a ROM 102, a RAM 103, a hard disk apparatus (HDD) 104, a communications controller 105, a panel controller 106, an input apparatus controller 107, an authentication apparatus controller 108, a print apparatus controller 109, an operation panel 100, an input apparatus 200 constituted from a keyboard and mouse or the like, a print apparatus (printer) 400, a power controller 500, and a print job controller 700. The details of the power controller 500 and the print job controller 700 will be described below with reference to the drawings.

The communications controller 105 is connected to each of terminal apparatuses 2, 3, and 4 via an unshown interface and a communications line TC or the like. A LAN, the Internet, public communications line, private communications line, or the like is used as the communications line TC.

The operation panel 100 is configured with an unshown operation portion that is configured from a touch-panel liquid crystal display (LCD) 100a and a numeric keypad and the like. In the liquid crystal display 100a, for example, a screen for giving an instruction or message to a user, a screen for the user to input a type of desired processing and processing conditions, and a screen that indicates the results of processing executed by the CPU 101 or the like, are displayed. Note that another display apparatus such as a CRT may be used instead of the operation panel 100.

By operating an unshown button or operation portion of the liquid crystal display 100a while viewing the above screens, a user can give the image forming apparatus 1 a command such as to start or stop execution of processing, or can designate a data destination, processing conditions such as print conditions or scan conditions, or various other items. That is, the operation panel 100 serves the role of an interface for a user that operates the image forming apparatus 1.

The CPU 101 collectively controls operation of the entire image forming apparatus 1. The ROM 102, the RAM 103, the hard disk apparatus 104, and the like are connected to a bus of the CPU 101.

The ROM 102 is a memory in which operation programs (control programs) of the CPU 101 have been stored. The RAM 103 supplies a work area when the CPU 101 operates, for opening a boot program or opening an operation program. The CPU 101 is capable of operating as a computer.

The hard disk 104 temporarily stores copy image data or image data from a terminal such as a personal computer, and stores data of a scanned image or the like.

The panel controller 106 controls operation of the operation panel 100. The input apparatus controller 107 controls operation of the input apparatus 200. The authentication apparatus controller 108 controls operation of the authentication apparatus 300. The print apparatus controller 109 controls operation of the print apparatus 400.

Following is a description of operation of the image forming apparatus 1.

As shown in FIG. 3, the power controller 500 includes an operation mode storage portion 501 and a power consumption controller 502. Further, the print job controller 700 is configured from, for example, a print job receiving portion 703, a job determination portion 704, a job holding portion 705 constituted from a box area of the hard disk apparatus 104, and an authentication information determination portion 706.

A CPU, a memory, and other circuit devices and the like are used as the power controller 500 and the print job controller 700. In this memory, computer programs for executing the functions of the power controller 500 and the print job controller 700 are incorporated. Such programs can be installed from a transportable recording medium BT that includes a recording medium BT1 such as a CD-ROM or DVD-ROM on which the programs have been recorded and a recording medium BT2 such as a semiconductor memory. The programs can also be downloaded from a server via a network.

The operation mode storage portion 501 stores a plurality of operation modes of the image forming apparatus 1. A user can use the operation panel 100 to set, for example, the operation start time, operation end time, and shift time of various operation modes.

The image forming apparatus 1 is provided with four operation modes: a normal standby mode, a low power mode and a sleep mode as power-saving modes, and a sleep print mode as a power-saving print mode.

As shown in FIG. 4, the standby mode is an operation mode in which power is supplied to the fixing unit 31, the print apparatus controller 109, the image reading apparatus 4, the communications controller 105, the authentication apparatus controller 108, the power controller 500, the liquid crystal display 100a, and the panel controller 106.

That is, the standby mode is an operation mode in which it is possible to immediately receive a print job, copy job, scan job, or the like desired by a user. In FIG. 4, constituent portions that are supplied with power in each operation mode are indicated by a circle, and constituent portions that are not supplied with power are indicated by an X.

Here, a group of constituent portions selected from among the fixing unit 31, the print apparatus controller 109, the image reading apparatus 4, the communications controller 105, the authentication apparatus controller 108, the print job controller 700, the power controller 500, the liquid crystal display 100a, and the panel controller 106 to be supplied with power by the power consumption controller 502 is referred to as a ‘power-receiving group 600’. The constituent portions that are supplied with power differs for each of the above operation modes, so the constituent portions included in the power-receiving group 600 differs for each of the above operation modes.

As shown in FIG. 4, in order to identify the type of constituent elements that are supplied with power in each operation mode, i.e., in order to identify the power-receiving group 600 in each operation mode, a first power-receiving group 600a is used as the power-receiving group 600 in the standby mode, a second power-receiving group 600b is used as the power-receiving group 600 in the low power mode, a third power-receiving group 600c is used as the power-receiving group 600 in the sleep mode, and a fourth power-receiving group 600d is used as the power-receiving group 600 in the sleep print mode.

Accordingly, the first power-receiving group 600a includes the fixing unit 31, the print apparatus controller 109, the image reading apparatus 4, the communications controller 105, the authentication apparatus controller 108, the print job controller 700, the power controller 500, the liquid crystal display 100a, and the panel controller 106.

The low power mode is an operation mode in which, stating only the points that differ from the above standby mode, the fixing unit 31 is controlled at low temperature (indicated by a triangle in FIG. 4), and power supply to the image reading apparatus 4, the liquid crystal display 100a, and the panel controller 106 is cut off. Thus, power consumption of the image forming apparatus 1 while standing by is reduced to less than when in the standby mode.

Accordingly, the second power-receiving group 600b includes the fixing unit 31, the print apparatus controller 109, the communications controller 105, the authentication apparatus controller 108, the print job controller 700, and the power controller 500.

The sleep mode is an operation mode in which power is supplied only to the communications controller 105, the authentication apparatus controller 108, the print job controller 700, and the power controller 500, and power supply to other constituent portions is cut off. That is, sleep mode is an operation mode in which power is supplied only to the minimum constituent elements necessary for startup when a network print job, a facsimile job, or the like has been received.

Accordingly, the third power-receiving group 600c includes the communications controller 105, the authentication apparatus controller 108, the print job controller 700, and the power controller 500.

During sleep mode operation, power-saving control such as partial image processing clock stoppage is performed also in unshown image processing portions that are not a condition for startup, and thus a further reduction in power consumption is realized.

When the operation mode of the image forming apparatus 1 is in standby mode, and operation is not performed by a user for a predetermined time, or a predetermined instruction has been performed by the operation panel 100, the operation mode of the image forming apparatus 1 may be controlled so as to shift to a power-saving mode such as the low power mode or the sleep mode. Also, the image forming apparatus 1 may be controlled such that the operation mode shifts to the standby mode when, for example, a document has been placed or the operation panel 100 has been operated by a user.

The time (shift time) at which the operation mode shifts from the standby mode to the low power mode or the sleep mode can be respectively set by a user. Also, a user can use the operation panel 100 to select either the low power mode or the sleep mode and perform the above predetermined instruction.

The sleep print mode is an operation mode in which power is supplied only to the fixing unit 31, the print apparatus controller 109, the communications controller 105, the authentication apparatus controller 108, the print job controller 700, and the power controller 500.

That is, the sleep print mode is an operation mode in which it is possible to immediately execute a print job desired by a user when that print job is received. In other words, the sleep print mode is an operation mode in which, unlike the standby mode, only when a print job has been received, and not a copy job or a scan job, power is supplied only to the minimum constituent elements necessary for executing the print job such that the print job can be executed immediately.

Accordingly, the fourth power-receiving group 600d includes the fixing unit 31, the print apparatus controller 109, the communications controller 105, the authentication apparatus controller 108, the print job controller 700, and the power controller 500.

Returning to FIG. 3, the print job receiving portion 703 receives a normal print job or an authenticated print job from the terminal apparatus 2, for example.

Here, an authenticated print job means a print job executed when a user that sent a print job (print data and a print instruction) from the terminal apparatus 2 to the image forming apparatus 1, for example, performed an authentication operation with the authentication apparatus 300 provided in the image forming apparatus 1, and that authentication was successful.

Below, the operation of each constituent element in a state in which the operation mode of the image forming apparatus 1 is set to the sleep mode will be described.

The job determination portion 704 determines whether a print job that has been received by the print job receiving portion 703 is a normal print job or an authenticated print job.

When the job determination portion 704 has determined that the print job is a normal print job, the job holding portion 705 temporarily stores image data for that print job.

Then, based on operation mode information that is stored in the operation mode storage portion 501, the power consumption controller 502 shifts the operation mode of the image forming apparatus 1 from the above sleep mode to the sleep print mode. That is, the power consumption controller 502 supplies power to the fixing unit 31, the print apparatus controller 109, the communications controller 105, the authentication apparatus controller 108, the print job controller 700, and the power controller 500. In other words, the power consumption controller 502 supplies power to the fourth power-receiving group 600d.

Then, the print apparatus controller 109 sends the image data temporarily stored in the job holding portion 705 to the print apparatus 400 for an image to be printed to paper based on that image data.

Then, the power consumption controller 502 again shifts the operation mode of the image forming apparatus 1 from the sleep print mode to the sleep mode. That is, the power consumption controller 502 supplies power to only the communications controller 105, the authentication apparatus controller 108, the print job controller 700, and the power controller 500. In other words, the power consumption controller 502 supplies power to the third power-receiving group 600c.

On the other hand, when the job determination portion 704 has determined that the print job is an authenticated print job, the job holding portion 705 stores image data for that authenticated print job.

Then, based on a predetermined authentication operation performed by a user with the authentication apparatus 300, the authentication information determination portion 706 determines whether or not the authenticated print job for which an ID and password of that user have been set is stored in the job holding portion 705. By performing this sort of authentication process, security is increased when executing a print job of a confidential document or the like.

The results of the authentication operation by the user may be displayed on the liquid crystal display 100a, or notification may be performed by sound. Also, as an example of setting a user ID or password in image data for an authenticated print job, the ID and password may be added to the image data as a background pattern.

When an authenticated print job corresponding to the user is stored in the job holding portion 705, the power consumption controller 502 shifts the operation mode of the image forming apparatus 1 from the sleep mode to the sleep print mode. In this case, the constituent portions supplied with power are as described above.

Afterward, the print apparatus controller 109 sends the image data of the authenticated print job that is stored in the job holding portion 705 to the print apparatus 400 for an image to be printed to paper based on that image data.

Then, the power consumption controller 502 again shifts the operation mode of the image forming apparatus 1 from the sleep print mode to the sleep mode. In this case, the constituent portions supplied with power are as described above.

Thus, in the present embodiment, the user can execute processing up to print output by only an authentication operation, so time and effort is not required.

On the other hand, when an authenticated print job corresponding to the user is not stored in the job holding portion 705, it is assumed that the user normally accessed the image forming apparatus 1, so the power consumption controller 502 shifts the operation mode of the image forming apparatus 1 from the sleep mode to the standby mode. In this case, the power consumption controller 502 supplies power to the fixing unit 31, the print apparatus controller 109, the image reading apparatus 4, the communications controller 105, the authentication apparatus controller 108, the power controller 500, the liquid crystal display 100a, and the panel controller 106. In other words, the power consumption controller 502 supplies power to the first power-receiving group 600a.

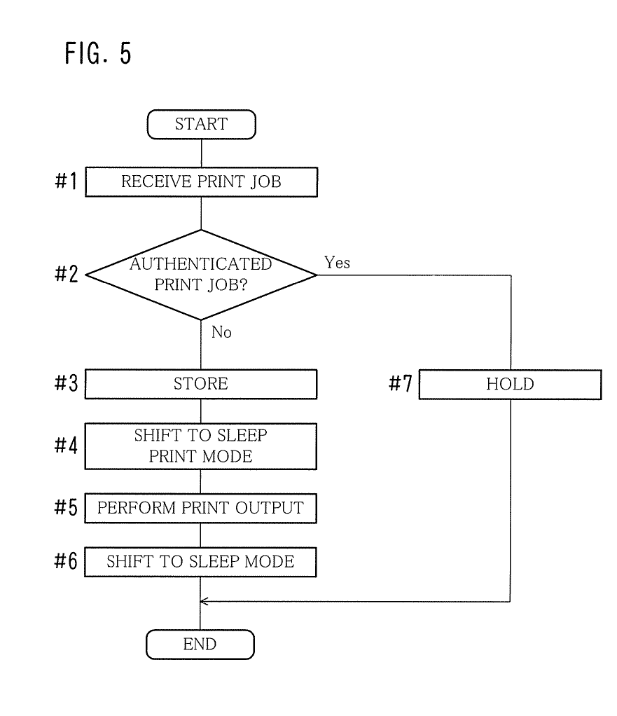

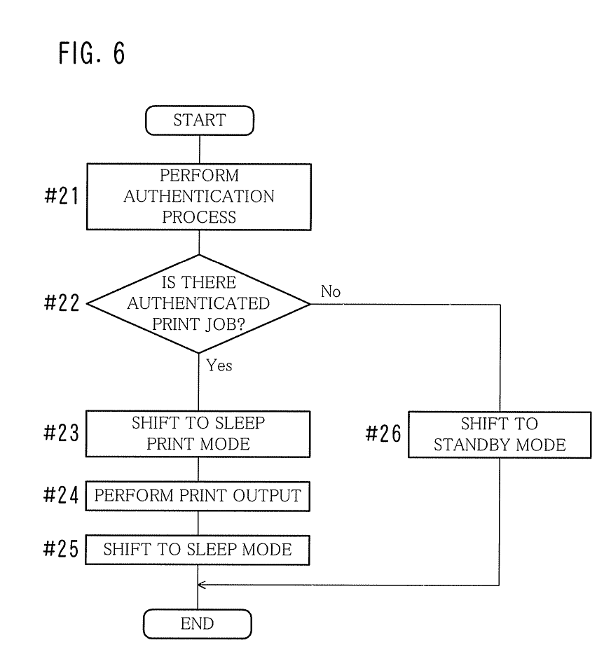

FIG. 5 is a flowchart that illustrates an example of the flow of an execution process of a normal print job, and FIG. 6 is a flowchart that illustrates an example of the flow of an execution process of an authenticated print job. The flowcharts in FIGS. 5 and 6 indicate the flow of a process in a state in which the operation mode of the image forming apparatus 1 has been set to the sleep mode.

In the normal printing shown in FIG. 5, first, a print job is received (#1). Then, a determination is made of whether the received print job is a normal print job or an authenticated print job (#2).

When the received print job is a normal print job (No in #2), the image data for that print job is temporarily stored on the hard disk apparatus 104 (#3).

Then, the operation mode of the image forming apparatus 1 is shifted from the sleep mode to the sleep print mode (#4).

An image based on the image data for that print job is printed on paper (#5), and then the operation mode of the image forming apparatus 1 is again shifted from the sleep print mode to the sleep mode (#6).

On the other hand, when the received print job is an authenticated print job (Yes in #2), the image data for that authenticated print job is held in the job holding portion 705 (#7).

As shown in FIG. 6, first, the above-described authentication process based on an authentication operation by a user is performed (#21), and then a determination is made of whether or not an authenticated print job corresponding to that user is being held in the job holding portion 705 (#22).

When an authenticated print job is being held in the job holding portion 705 (Yes in #22), the operation mode of the image forming apparatus 1 is shifted from the sleep mode to the sleep print mode (#23).

An image based on the image data for that authenticated print job is printed on paper (#24), and then the operation mode of the image forming apparatus 1 is shifted from the sleep print mode to the sleep mode (#25).

On the other hand, when an authenticated print job is not being held in the job holding portion 705 (No in #22), the operation mode of the image forming apparatus 1 is shifted from the sleep mode to the standby mode (#26).

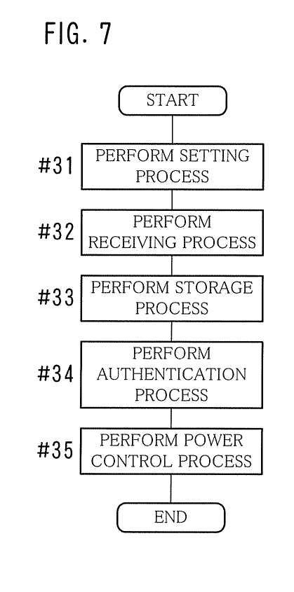

FIG. 7 is a flowchart that illustrates an example of the flow of a process for reducing power consumption.

As shown in FIG. 7, first, a setting process (power control process) is performed to set the operation mode of the image forming apparatus 1 to the sleep mode as a power-saving mode (#31).

Next, an authenticated print job is received (#32), and image data for the authenticated print job is stored (#33).

Authentication is performed based on a predetermined operation by a user (#34), and then, before a print process is performed, without shifting the operation mode of the image forming apparatus 1 from the sleep mode to the normal standby mode, the operation mode of the image forming apparatus 1 is shifted to the sleep print mode as a power-saving print mode, and after the print process has been performed, a power control process is performed that returns the operation mode from the sleep print mode to the sleep mode (#35).

In the present embodiment, in a state in which the operation mode of the image forming apparatus 1 is the sleep mode, when an authenticated print job that corresponds to a user that performed an authentication operation is being held in the job holding portion 705, without the operation mode of the image forming apparatus 1 being returned to the normal standby mode, the operation mode of the image forming apparatus 1 is shifted to the sleep print mode, in which power is supplied only to the minimum constituent elements necessary for executing a print job.

By such a method, it is possible to reduce power consumption relative to a conventional image forming apparatus, in which when a print job has been sent from a terminal apparatus, if there is an authentication operation by a user, the operation mode is shifted from the sleep mode to the normal standby mode.

Also, in the present embodiment, after execution of a print job, the operation mode of the image forming apparatus 1 is immediately shifted from the sleep print mode to the sleep mode. By such a method, it is possible to reduce power consumption relative to a conventional image forming apparatus, in which even after print output ends, the normal standby mode is maintained until a preset time for shifting to the sleep mode passes.

Therefore, with the image forming apparatus 1 according to the present embodiment, it is possible to markedly reduce unnecessary power consumption relative to a conventional image forming apparatus by effectively using authentication results when performing an authenticated print job.

Furthermore, in the present embodiment, a user can execute processing up to print output by only an authentication operation, so time and effort is not required, relative to a conventional image forming apparatus, in which the operation mode is returned to the standby mode based on a first authentication operation, and an authentication process is performed based on a second authentication operation. As a result, convenience of the image forming apparatus 1 is improved relative to a conventional image forming apparatus.

### Other Embodiments

In the above embodiment, an example is described in which the image forming apparatus 1 is provided with the authentication apparatus 300, and a user performs a predetermined authentication operation with the authentication apparatus 300. However, instead of the authentication apparatus 300, an authentication operation may be performed by using the operation panel 100 to input a user ID and password. In this case, power is supplied to the panel controller 106 in four operation modes: the standby mode, the low power mode, the sleep mode, and the sleep print mode.

Furthermore, the configuration of all or any portion of the image forming apparatus 1, content or order of processing, or the like can be appropriately modified according to the gist of the invention, and in this case as well the above characteristic and exceptional effects are exhibited.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image forming apparatus configured to perform printing based on image data of a print job inputted from an external device, the image forming apparatus comprising:
a power controller setting an operation mode of the image forming apparatus to any one of a normal standby mode, a power-saving mode and a power-saving print mode by changing a power supply destination in the image forming apparatus, the power-saving print mode being a mode for supplying power to the power supply destination necessary for executing the print job;
a receiving portion receiving an authenticated print job that is a print job executed when authentication of a user who has inputted the print job through the external device is successful;
a storage portion storing image data of the authenticated print job received by the receiving portion;
an authentication information determination portion performing authentication based on a predetermined operation performed by the user; and
a printer printing an image based on the image data stored in the storage portion when the authentication information determination portion determines that the authentication of the user is successful,
when the operation mode is set to the power-saving mode, the power controller changing the operation mode from the power-saving mode to the power-saving print mode without changing the operation mode from the power-saving mode to the normal standby mode after the authentication information determination portion has determined that the authentication of the user is successful and before the printer performs printing, and the power controller returning the operation mode from the power-saving print mode to the power-saving mode after the printer has performed the printing.

2. The image forming apparatus according to claim 1, further comprising
a print controller controlling a fixing unit and the printer, and
a reader reading a document to generate image data, wherein, in the power-saving print mode, the power controller supplies power to the print controller and does not supply power to the reader.

3. The image forming apparatus according to claim 2, wherein, in the power-saving mode, the power controller does not supply power to the fixing unit, the print controller and the reader.

4. The image forming apparatus according to claim 2, wherein, in the power-saving mode, the power controller reduces power to be supplied to the fixing unit.

5. The image forming apparatus according to claim 1, further comprising a notifying portion notifying a result of the authentication performed by the authentication information determination portion.

6. The image forming apparatus according to claim 1, wherein the power controller changes the operation mode from the power-saving mode to the normal standby mode when the authentication information determination portion has determined that the authentication of the user is unsuccessful.

7. A method for controlling an image forming apparatus configured to perform printing based on image data of a print job inputted from an external device, the method comprising:
a power control step of setting an operation mode of the image forming apparatus to any one of a normal standby mode, a power-saving mode and a power-saving print mode by changing a power supply destination in the image forming apparatus, the power-saving print mode being a mode for supplying power to the power supply destination necessary for executing the print job;
a receiving step of receiving an authenticated print job that is a print job executed when authentication of a user who has inputted the print job through the external device is successful;
a storage step of storing image data of the authenticated print job received in the receiving step;
an authentication step of performing authentication based on a predetermined operation performed by the user; and a print step of printing an image based on the image data stored in the storage step when it is determined, in the authentication step, that the authentication of the user is successful,
in the power control step, when the operation mode is set to the power-saving mode, the operation mode being changed from the power-saving mode to the power-saving print mode without changing the operation mode from the power-saving mode to the normal standby mode after it has been determined, in the authentication step, that the authentication of the user is successful and before printing is performed in the print step, and the operation mode being returned from the power-saving print mode to the power-saving mode after the printing has been performed.

8. The method according to claim 7, wherein, in the power-saving print mode, power is supplied to a print controller controlling a fixing unit and a printer, and no power is supplied to a reader reading a document to generate image data.

9. The method according to claim 8, wherein, in the power-saving mode, no power is supplied to the fixing unit, the print controller and the reader.

10. A recording medium storing thereon a computer program executed by a computer included in an image forming apparatus configured to perform printing based on image data of a print job inputted from an external device, the computer program causing the computer to execute:
a power control process of setting an operation mode of the image forming apparatus to any one of a normal standby mode, a power-saving mode and a power-saving print mode by changing a power supply destination in the image forming apparatus, the power-saving print mode being a mode for supplying power to the power supply destination necessary for executing the print job;
a receiving process of receiving an authenticated print job that is a print job executed when authentication of a user who has inputted the print job through the external device is successful;
a storage process of storing image data of the authenticated print job received in the receiving process;
an authentication process of performing authentication based on a predetermined operation performed by the user; and
a print process of printing an image based on the image data stored in the storage process when it is determined, in the authentication process, that the authentication of the user is successful,
in the power control process, when the operation mode is set to the power-saving mode, the operation mode being changed from the power-saving mode to the power-saving print mode without changing the operation mode from the power-saving mode to the normal standby mode after it has been determined, in the authentication process, that the authentication of the user is successful and before printing is performed in the print process, and the operation mode being returned from the power-saving print mode to the power-saving mode after the printing has been performed.
